(19) United States
(12) Patent Application Publication
(10) Pub. No.: US 2022/0295833 A1
(43) Pub. Date: Sep. 22, 2022

(54) SWEETENER BLENDS WITH IMPROVED TASTE

(71) Applicant: The Coca-Cola Company, Atlanta, GA (US)

(72) Inventors: Juvenal Higiro, Atlanta, GA (US); Indra Prakash, Alpharetta, GA (US); Rebeka Melo Pansani, Rio de Janeiro (BR)

(21) Appl. No.: 17/763,922

(22) PCT Filed: Sep. 28, 2020
(86) PCT No.: PCT/US2020/053011

§ 371 Date: Mar. 25, 2022

Related U.S. Application Data
(60) Provisional application No. 62/907,413, filed on Sep. 27, 2019.

(51) Int. Cl. A23L 2/60; A23L 27/30; A23L 2/66; A23L 2/54; A23L 11/65

(52) U.S. Cl. CPC A23L 2/60; A23L 27/36; A23L 2/66; A23L 2/54; A23L 27/37; A23L 27/34; A23L 11/65; A23V 2002/00

(57) ABSTRACT

Beverage syrups and finished beverages comprising a sweetener blend of a steviol glycoside mixture comprising rebaudioside M and certain synthetic sweeteners in particular amounts that provide improved sensory profiles are described herein. Also provided are methods of preparing beverage syrups and finished beverages.

### CROSS REFERENCE TO RELATED APPLICATIONS

This application claims priority to U.S. Provisional Patent Application No. 62/907,413, filed Sep. 27, 2019, incorporated herein in its entirety.

### FIELD OF THE INVENTION

The present invention relates generally to beverages comprising a sweetener blend of a steviol glycosides mixture comprising rebaudioside M and certain synthetic sweeteners in particular amounts, as well as beverage syrups and beverages prepared with said sweetener blends.

### BACKGROUND OF THE INVENTION

Natural caloric sugars, such as sucrose, fructose and glucose, are utilized to provide a pleasant taste to beverages, foods, pharmaceuticals, and oral hygienic/cosmetic products. Sucrose, in particular, imparts a taste preferred by consumers. Although sucrose provides superior sweetness characteristics, it is disadvantageously caloric.

Non-caloric or low caloric sweeteners have been introduced to satisfy consumer demand. However, non- and low caloric sweeteners taste different from natural caloric sugars in ways that frustrate consumers. On a taste basis, non-caloric or low caloric sweeteners exhibit a temporal profile, maximal response, flavor profile, mouth feel, and/or adaptation behavior that differ from sugar. Specifically, non-caloric or low caloric sweeteners exhibit delayed sweetness onset, lingering sweet aftertaste, bitter taste, metallic taste, astringent taste, cooling taste and/or licorice-like taste. On a source basis, many non-caloric or low caloric sweeteners are synthetic chemicals. Consumer desire for low caloric beverages that minimize the use of synthetic chemicals but tastes like sucrose remains high.

A steviol glycoside concentration of at least 0.25% (% w/w) is useful for beverage syrups. Syrups having such concentrations can readily be diluted to beverages. However, a number of steviol glycosides have poor aqueous solubility and cannot be formulated into beverage syrups without use of additives, heat and/or special equipment. For example, the aqueous solubility of Rebaudioside B, Rebaudioside D and Rebaudioside M is from about 0.05-0.1 wt %. Rebaudioside A, by comparison, has a relatively high aqueous solubility of about 0.8 wt %.

Accordingly, there remains a need to develop sweetener blends containing rebaudioside M that can be formulated into beverage syrups using conventional methods.

### SUMMARY OF THE INVENTION

In one aspect, the present invention provides a sweetener blend comprising (i) a steviol glycoside mixture comprising rebaudioside M and (ii) at least one synthetic sweetener.

The steviol glycoside mixture comprising rebaudioside M can be selected from a steviol glycoside mixture containing at least 80% rebaudioside M by weight and a steviol glycoside mixture comprising at least 95% rebaudioside M by weight.

The amount of the steviol glycoside mixture comprising rebaudioside M in the sweetener blend is sufficient to provide a concentration from about 1 ppm to about 250 ppm when the blend is formulated into the beverage.

The at least one synthetic sweetener is selected from the group consisting of sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

The amount of the at least one synthetic sweetener is sufficient to provide a concentration of about 1 ppm to about 250 when the blend is formulated into a beverage.

The weight ratio of the steviol glycoside mixture comprising rebaudioside M to at least one synthetic sweetener is from about 0.5:1 to about 3:1, such as, for example, from about 1:1 to about 2:1.

The sweetener blends can optionally include one or more substances selected from the group consisting of erythritol, allulose, cellobiose, hesperetin dihydrochalcone-4′ glucoside and/or phloretin.

In another aspect, beverage syrups comprising a sweetener blend described herein are provided. The beverage syrups of the present invention can be formulated without heating or specialty equipment needed to address poor steviol glycoside solubility.

In still another aspect, a method for preparing a beverage syrup comprises combining (i) one or more beverage syrup ingredients with (ii) water to provide a beverage syrup. The one or more beverage ingredients includes, but is not limited to, the sweetener blend of the present invention, additives, functional ingredients, buffers and flavor ingredients.

In yet another aspect, a beverage comprising a sweetener blend described herein is provided. The beverage is preferably a carbonated beverage or a plant protein-containing beverage.

The beverage can be selected from a full-calorie, mid-calorie, low-calorie or zero-calorie beverage. In a particular embodiment, the beverage is a zero-calorie carbonated beverage.

In a still further aspect, a method of preparing a beverage comprises mixing a beverage syrup described herein with an appropriate amount of mixing water.

The beverages can optionally contain at least one functional ingredient and/or additive.

### DETAILED DESCRIPTION OF THE INVENTION

### I. Blends of Reb M and Synthetic Sweeteners

In one embodiment, the present invention provides a sweetener blend comprising (i) a steviol glycoside mixture comprising rebaudioside M and (ii) at least one synthetic sweetener.

It has been found that, when mixed in particular weight ratios and/or concentrations, beverages containing the sweetener blends described herein exhibit improved sensory properties compared to beverages containing only a mixture of synthetic sweeteners. More particularly, it has been found that replacing one of the synthetic sweeteners of a synthetic blend in a beverage (e.g. sucralose/acesulfame K blends) with a steviol glycoside mixture comprising rebaudioside M provides a beverage with improved sensory properties.

“Steviol glycoside mixture comprising rebaudioside M”, as used herein, refers to a mixture of steviol glycosides containing at least about 80% rebaudioside M by weight, such as, for example, at least about 85% rebaudioside M by weight, at least about 90% rebaudioside M by weight, at least about 95% rebaudioside M by weight or at least about 97% rebaudioside M by weight.

In a particular embodiment, the steviol glycoside mixture comprising rebaudioside M can be RebM80. “RebM80” refers to a steviol glycoside mixture containing at least 80% Reb M by weight. The total steviol glycoside content of the mixture is at least 95%.

In another particular embodiment, the steviol glycoside mixture comprising rebaudioside M can also be 95% rebaudioside M, i.e. a steviol glycoside mixture comprising rebaudioside M in about 95% by weight.

The remainder of the steviol glycoside mixture comprises steviol glycosides other than rebaudioside M. Exemplary steviol glycosides include, but are not limited to, rebaudioside D, rebaudioside A, rebaudioside N, rebaudioside 0, rebaudioside E, steviolmonoside, steviolbioside, rubusoside, dulcoside B, dulcoside A, rebaudioside B, rebaudioside G, stevioside, rebaudioside C, rebaudioside F, rebaudioside I, rebaudioside H, rebaudioside L, rebaudioside K, rebaudioside J, rebaudioside M2, rebaudioside D2, rebaudioside S, rebaudioside T, rebaudioside U, rebaudioside V, rebaudioside W, rebaudioside Z1, rebaudioside Z2, rebaudioside IX, enzymatically glucosylated steviol glycosides and combinations thereof.

The amount of rebaudioside M in the blend can vary. In a particular embodiment, rebaudioside M is present in an amount sufficient to provide a concentration of about 1 ppm to about 250 ppm when formulated into a beverage, such as, for example, from about 10 ppm to about 250 ppm, from about 50 ppm to about 250 ppm, from about 100 ppm to about 250 ppm, from about 150 ppm to about 250 ppm, from about 10 ppm to about 200 ppm, from about 50 ppm to about 200 ppm, from about 100 ppm to about 200 ppm, from about 10 ppm to about 100 ppm, from about 50 ppm to about 100 ppm and from about 10 ppm to about 50 ppm.

The at least one synthetic sweetener can be any synthetic sweetener known to those of skill in the art. Exemplary synthetic sweeteners include, but are not limited to, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

The amount of the at least one synthetic sweetener can vary. In a particular embodiment, the at least one synthetic sweetener is present in an amount sufficient to provide a concentration of about 1 ppm to about 250 ppm when formulated into a beverage, such as, for example, from about 10 ppm to about 250 ppm, from about 50 ppm to about 250 ppm, from about 100 ppm to about 250 ppm, from about 150 ppm to about 250 ppm, from about 10 ppm to about 200 ppm, from about 50 ppm to about 200 ppm, from about 100 ppm to about 200 ppm, from about 10 ppm to about 100 ppm, from about 50 ppm to about 100 ppm and from about 10 ppm to about 50 ppm.

The concentration of the at least one synthetic sweetener can refer to the concentration of an individual synthetic sweetener or the combined concentration of multiple synthetic sweeteners.

Surprisingly, it has been found that the weight ratio of the steviol glycoside comprising rebaudioside M to at least one synthetic sweetener affects the taste of the resulting beverage. In particular, the weight ratio of the steviol glycoside comprising rebaudioside M to at least one synthetic sweetener is from 0.5:1 to 3:1, such as, for example, from about 0.5:1 to about 2:1, from about 0.5:1 to about 1:1, from about 1:1 to about 3:1, from about 1:1 to about 2:1 and from about 2:1 to about 3:1.

In a particular embodiment, a sweetener blend comprises (i) a steviol glycoside mixture comprising rebaudioside M and (ii) at least one synthetic sweetener, wherein the weight ratio of the steviol glycoside comprising rebaudioside M to at least one synthetic sweetener is from 0.5:1 to 3:1.

In a more particular embodiment, a sweetener blend comprises (i) a steviol glycoside mixture comprising rebaudioside M in an amount sufficient to provide a rebaudioside M concentration from about 1 ppm to about 250 ppm when formulated into a beverage and (ii) at least one synthetic sweetener in an amount sufficient to provide a concentration of the at least one synthetic sweetener from about 1 ppm to about 250 ppm when formulated into a beverage.

In a still further particular embodiment, a sweetener blend comprises (i) a steviol glycoside mixture comprising rebaudioside M in an amount sufficient to provide a rebaudioside M concentration from about 1 ppm to about 250 ppm when formulated into a beverage and (ii) at least one synthetic sweetener in an amount sufficient to provide a concentration of the at least one synthetic sweetener from about 1 ppm to about 250 ppm when formulated into a beverage, wherein the weight ratio of the steviol glycoside comprising rebaudioside M to at least one synthetic sweetener is from 0.5:1 to 3:1.

It has also been found that addition of erythritol, allulose, cellobiose, hesperetin dihydrochalcone-4′-O-β-D-glucoside and/or phloretin further improves the sensory profiles of beverages comprising the sweetener blends described above. Accordingly, the sweetener blends of the present invention can further comprise one or more substances selected from the group consisting of erythritol, allulose, cellobiose, hesperetin dihydrochalcone-4′-O-β-D-glucoside and/or phloretin.

The amount of erythritol, allulose and cellobiose can vary. In one embodiment, a sweetener blend of the present invention comprises at least one of erythritol, allulose and/or cellobiose in an amount from about 0.1% to about 2% by weight when formulated into a beverage, such as for example, from about 0.5% to about 2% by weight, from about 0.5% to about 1% by weight or from about 1% to about 2% by weight. In a particular embodiment, a sweetener blend comprises erythritol in an amount from about 0.1% to about 2% by weight when formulated into a beverage, such as for example, from about 0.5% to about 2% by weight, from about 0.5% to about 1% by weight or from about 1% to about 2% by weight. In another particular embodiment, a sweetener blend comprises allulose in an amount from about 0.1% to about 2% by weight when formulated into a beverage, such as for example, from about 0.5% to about 2% by weight, from about 0.5% to about 1% by weight or from about 1% to about 2% by weight. In still another particular embodiment, a sweetener blend comprises cellobiose in an amount from about 0.1% to about 2% by weight when formulated into a beverage, such as for example, from about 0.5% to about 2% by weight, from about 0.5% to about 1% by weight or from about 1% to about 2% by weight.

The amount of phloretin can also vary. In one embodiment, a sweetener blend of the present invention comprises phloretin in an amount sufficient to provide a phloretin concentration from about 0.1 ppm to about 15 ppm when formulated into a beverage, such as, for example, from about 0.1 ppm to about 10 ppm, from about 0.1 ppm to about 5 ppm, from about 0.1 ppm to about 3 ppm, from about 1 ppm to about 15 ppm, from about 1 ppm to about 10 ppm, from about 1 ppm to about 5 ppm, from about 1 ppm to about 3 ppm, from about 3 ppm to about 15 ppm, from about 3 ppm to about 10 ppm, from about 3 ppm to about 5 ppm, from about 5 ppm to about 15 ppm, from about 5 ppm to about 10 ppm and from about 10 ppm to about 15.

The amount of hesperetin dihydrochalcone-4′-O-β-D-glucoside can also vary. In one embodiment, a sweetener blend of the present invention comprises hesperetin dihydrochalcone-4′-O-β-D-glucoside in an amount sufficient to provide a hesperetin dihydrochalcone-4′-O-β-D-glucoside concentration from about 0.1 ppm to about 20 ppm when formulated into a beverage, such as, for example, from about 0.1 to about 15 ppm, from about 0.1 ppm to about 10 ppm, from about 0.1 ppm to about 5 ppm, from about 1 ppm to about 20 ppm, from about 1 ppm to about 15 ppm, from about 1 ppm to about 10 ppm, from about 1 ppm to about 5 ppm, from about 5 ppm to about 20 ppm, from about 5 ppm to about 15 ppm, from about 5 ppm to about 10 ppm, from about 10 ppm to about 20 ppm, from about 10 ppm to about 15 ppm and from about 15 ppm to about 20 ppm.

In a particular embodiment, a sweetener blend comprises (i) a steviol glycoside mixture comprising rebaudioside M, (ii) at least one synthetic sweetener, wherein the weight ratio of the steviol glycoside comprising rebaudioside M to at least one synthetic sweetener is from 0.5:1 to 3:1 and (iii) erythritol.

In a more particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage and (iii) erythritol in an amount sufficient to provide from about 0.1% to about 2% by weight when formulated into a beverage.

In a still further particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage, wherein the weight ratio of the steviol glycoside comprising rebaudioside M to at least one synthetic sweetener is from 0.5:1 to 3:1 and (iii) erythritol in an amount sufficient to provide about 0.1% to about 2% by weight when formulated into a beverage.

In another embodiment, a sweetener blend comprises (i) a steviol glycoside mixture comprising rebaudioside M, (ii) at least one synthetic sweetener, wherein the weight ratio of the steviol glycoside comprising rebaudioside M to at least one synthetic sweetener is from 0.5:1 to 3:1 and (iii) allulose.

In a more particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage and (iii) allulose in an amount sufficient to provide from about 0.1% to about 2% by weight when formulated into a beverage.

In a still further particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage, wherein the weight ratio of the steviol glycoside comprising rebaudioside M to at least one synthetic sweetener is from 0.5:1 to 3:1 and (iii) allulose in an amount sufficient to provide about 0.1% to about 2% by weight when formulated into a beverage.

In another embodiment, a sweetener blend comprises (i) a steviol glycoside mixture comprising rebaudioside M, (ii) at least one synthetic sweetener, wherein the weight ratio of the steviol glycoside comprising rebaudioside M to at least one synthetic sweetener is from 0.5:1 to 3:1 and (iii) cellobiose.

In a more particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage and (iii) cellobiose in an amount sufficient to provide from about 0.1% to about 2% by weight when formulated into a beverage.

In a still further particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage, wherein the weight ratio of the steviol glycoside comprising rebaudioside M to at least one synthetic sweetener is from 0.5:1 to 3:1 and (iii) cellobiose in an amount sufficient to provide about 0.1% to about 2% by weight when formulated into a beverage.

In another embodiment, a sweetener blend comprises (i) a steviol glycoside mixture comprising rebaudioside M, (ii) at least one synthetic sweetener, wherein the weight ratio of the steviol glycoside comprising rebaudioside M to at least one synthetic sweetener is from 0.5:1 to 3:1 and (iii) hesperetin dihydrochalcone-4′-O-β-D-glucoside in an amount sufficient to provide a concentration from about 0.1 ppm to about 20 ppm when formulated into a beverage.

In a more particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage and (iii) hesperetin dihydrochalcone-4′-O-β-D-glucoside in an amount sufficient to provide a concentration from about 0.1 ppm to about 20 ppm when formulated into a beverage.

In a still further particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage, wherein the weight ratio of the steviol glycoside comprising rebaudioside M to at least one synthetic sweetener is from 0.5:1 to 3:1 and (iii) hesperetin dihydrochalcone-4′-O-β-D-glucoside in an amount sufficient to provide a concentration from about 0.1 ppm to about 20 ppm when formulated into a beverage.

In another embodiment, a sweetener blend comprises (i) a steviol glycoside mixture comprising rebaudioside M, (ii) at least one synthetic sweetener, wherein the weight ratio of the steviol glycoside comprising rebaudioside M to at least one synthetic sweetener is from 0.5:1 to 3:1 and (iii) phloretin.

In a more particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage and (iii) phloretin in an amount sufficient to provide a concentration from about 0.1 ppm to about 15 ppm when formulated into a beverage.

In a still further particular embodiment, a sweetener blend comprises (i) a steviol glycoside mixture comprising rebaudioside M in an amount sufficient to provide a rebaudioside M concentration from about 1 ppm to about 250 ppm when formulated into a beverage, (ii) at least one synthetic sweetener in an amount sufficient to provide a concentration of the at least one synthetic sweetener from about 1 ppm to about 250 ppm when formulated into a beverage, wherein the weight ratio of the steviol glycoside comprising rebaudioside M to at least one synthetic sweetener is from the steviol glycoside comprising rebaudioside M to at least one synthetic sweetener is from 0.5:1 to 3:1 and (iii) phloretin in an amount sufficient to provide a concentration from about 0.1 ppm to about 15 ppm when formulated into a beverage.

### II. Beverage Syrups

The present invention also provides beverage syrups comprising a sweetener blend described hereinabove and methods of making said beverage syrups.

“Syrup” or “beverage syrup”, as used herein, refers to a concentrated beverage precursor to which a fluid, typically water, is added to form a ready-to-drink beverage, or a “beverage.” Typically, the volumetric ratio of syrup to water is between 1:3 to 1:8, more typically between 1:4 and 1:6. The volumetric ratio of syrup to water also is expressed as a “throw.” A 1:5 ratio, which is a ratio commonly used within the beverage industry, is known as a “1+5 throw.”

By limiting the amount of the steviol glycoside mixture comprising rebaudioside M in the sweetener blend to that which provides a concentration of about 250 ppm (i.e. a steviol glycoside concentration of 0.025 wt %) and below in a finished beverage, beverage syrups can be prepared without the use of a heating step or rebaudioside M dosing skid.

In addition to the sweetener blend described herein, the beverage syrup can optionally include additional functional ingredients and/or additives, described hereinbelow.

Beverage syrups of the present invention are solutions, i.e. they are not cloudy and there are no precipitates or particulates present for at least about 6 hours after preparation. In some embodiments, the beverage syrup is clear by visual inspection for at least 1 day, at least 3 days, at least 7 days, at least 14 days, at least one month, at least 3 months or at least 6 months or more.

In one embodiment, a method of making a beverage syrup comprises combining (i) one or more beverage syrup ingredients with (ii) water to provide a beverage syrup. The one or more beverage ingredients includes, but is not limited to, the sweetener blend of the present invention, additives, functional ingredients, buffers, flavor ingredients, etc.

In a particular embodiment, the beverage syrup is used to prepare a diet carbonated beverage without heating or additional equipment, e.g. dosing skids

The skilled practitioner recognizes that beverage syrup ingredients can be added singularly or in combination. Also, solutions of dry beverage syrup ingredients can be made and used to add to the bulk quantity of water. Beverage syrup ingredients typically are added to the bulk quantity of water in an order that minimizes potential adverse interactions between ingredients or potential adverse effect on an ingredient. For example, nutrients that are temperature-sensitive might be added during a relatively low-temperature portion toward the end of the manufacturing process. Similarly, flavors and flavor compounds often are added just before completion of the syrup to minimize potential loss of volatile components and to minimize flavor loss in any form. Often, acidification is one of the last steps, typically carried out before temperature-sensitive, volatile, and flavor materials are added. Thus, flavors or flavor components or other volatile materials and nutrients typically are added at an appropriate time and at an appropriate temperature.

The pH of the beverage syrup is typically from about 2.0 to about 5, such as, for example, from about 2.5 to about 4. The pH may be adjusted by addition of a suitable acid or base such as, but not limited to phosphoric acid, citric acid, or sodium hydroxide.

The beverage syrup is packaged and may be stored. A beverage syrup may be used essentially immediately to manufacture beverages, which typically are packaged for distribution. A beverage syrup also may be distributed to bottlers, who then package beverages made by addition of water and perhaps other materials like carbonation.

The beverage syrup can be a full-calorie beverage syrup such that a ready-to-drink beverage prepared from the beverage syrup has up to about 120 calories per 8 oz serving.

The beverage syrup can be a mid-calorie beverage syrup, such that a ready-to-drink beverage prepared from the beverage syrup has up to about 60 calories per 8 oz. serving.

The beverage syrup can be a low-calorie beverage syrup, such that a ready-to-drink beverage prepared from the beverage syrup has up to about 40 calories per 8 oz. serving.

The beverage syrup can be a zero-calorie beverage syrup, such that a ready-to-drink beverage prepared from the beverage syrup has less than about 5 calories per 8 oz. serving.

### III. Beverages

The present invention also provides beverages comprising the sweetener blends described hereinabove and methods of making said beverages

The beverage can be a full-calorie beverage that has up to about 120 calories per 8 oz serving.

The beverage can be a mid-calorie beverage that has up to about 60 calories per 8 oz. serving.

The beverage can be a low-calorie beverage that has up to about 40 calories per 8 oz. serving.

The beverage can be a zero-calorie that has less than about 5 calories per 8 oz. serving.

In a particular embodiment, the present invention relates to mid-, low- or zero-calorie carbonated beverages containing the sweetener blends described herein. Carbonated beverages include, but are not limited to, frozen carbonated beverages, enhanced sparkling beverages, cola, fruit-flavored sparkling beverages (e.g. lemon-lime, orange, grape, strawberry and pineapple), ginger-ale, soft drinks and root beer.

In another particular embodiment, the present invention relates to beverages containing plant protein (a “plant protein-containing beverage”), e.g. soy, oat or nuts. Particular plant protein-containing beverages include, but are not limited to, coconut milk, oat milk, cashew milk, almond milk and soy milk.

In another embodiment, the present invention relates to dairy-containing beverages, i.e. beverages containing milk components. Exemplary dairy beverages include, but are not limited to milk beverages, coffee containing milk components, café au lait, milk tea and fruit milk beverages

The pH of the beverage is preferably about 7 or below, e.g. the pH of the beverage is <7. Exemplary pH ranges for beverages of the present invention are from about 1 to about 7, from about 2 to about 7, from about 3 to about 7, from about 4 to about 7, from 5 about to about 7, from 6 about to about 7, from about 1 to about 6, from about 2 to about 6, from about 3 to about 6, from about 4 to about 6, from about 5 to about 6, from about 1 to about 5, from about 2 to about 5, from about 3 to about 5, from about 4 to about 5, from about 1 to about 4, from about 2 to about 4, from about 3 to about 4, from about 1 to about 3, from about 2 to about 3 and from about 1 to about 2.

In one embodiment, a beverage has a sucrose equivalence (SE) of about 1% (w/v), such as, for example, about 2%, about 3%, about 4%, about 5%, about 6%, about 7%, about 8%, about 9%, about 10%, about 11%, about 12%, about 13%, about 14% or any range between these values.

In another embodiment, a beverage has a SE from about 2% to about 14%, such as, for example, from about 2% to about 10%, from about 2% to about 5%, from about 5% to about 15%, from about 5% to about 10% or from about 10% to about 15%.

The concentration of rebaudioside M in the blend can vary. In a particular embodiment, rebaudioside M is present in a concentration of about 1 ppm to about 250 ppm, such as, for example, from about 10 ppm to about 250 ppm, from about 50 ppm to about 250 ppm, from about 100 ppm to about 250 ppm, from about 150 ppm to about 250 ppm, from about 10 ppm to about 200 ppm, from about 50 ppm to about 200 ppm, from about 100 ppm to about 200 ppm, from about 10 ppm to about 100 ppm, from about 50 ppm to about 100 ppm and from about 10 ppm to about 50 ppm.

The concentration of the at least one synthetic sweetener can vary. In a particular embodiment, the at least one synthetic sweetener is present in a concentration of about 1 ppm to about 250 ppm, such as, for example, from about 10 ppm to about 250 ppm, from about 50 ppm to about 250 ppm, from about 100 ppm to about 250 ppm, from about 150 ppm to about 250 ppm, from about 10 ppm to about 200 ppm, from about 50 ppm to about 200 ppm, from about 100 ppm to about 200 ppm, from about 10 ppm to about 100 ppm, from about 50 ppm to about 100 ppm and from about 10 ppm to about 50 ppm.

The concentration of the at least one synthetic sweetener can refer to the concentration of an individual synthetic sweetener or the combined concentration of multiple synthetic sweeteners. Exemplary synthetic sweeteners include, but are not limited to, sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

In one embodiment, the at least one synthetic sweetener is sucralose. In a particular embodiment, the sucralose is present in a concentration from about 1 ppm to about 250 ppm, such as, for example, from about 10 ppm to about 50 ppm, from about 50 ppm to about 200 ppm or from about 75 ppm to about 100 ppm.

In another embodiment, the at least one synthetic sweetener is acesulfame K. In a particular embodiment, the acesulfame K is present in a concentration from about 1 ppm to about 250 ppm, such as, for example, from about 150 ppm to about 250 ppm or 200 ppm.

In still another embodiment, the at least one synthetic sweetener is saccharin. In a particular embodiment, the saccharin is present in a concentration from about 1 ppm to about 250 ppm, such as, for example, from about 100 ppm to about 200 ppm or about 140 ppm.

In a particular embodiment, a beverage comprises (i) a steviol glycoside mixture comprising rebaudioside M and (ii) at least one synthetic sweetener.

Surprisingly, it has been found that the weight ratio of the steviol glycoside comprising rebaudioside M to at least one synthetic sweetener affects the taste of the beverage. In particular, the weight ratio of the steviol glycoside comprising rebaudioside M to at least one synthetic sweetener is from 0.5:1 to 3:1, such as, for example, from about 0.5:1 to about 2:1, from about 0.5:1 to about 1:1, from about 1:1 to about 3:1, from about 1:1 to about 2:1 and from about 2:1 to about 3:1.

In embodiments where the beverage is a carbonated beverage, the weight ratio is preferably from about 1:1 to about 2:1. In embodiments where the beverage is a plant protein-containing beverage, the weight ratio is preferably from about 0.5:1 to about 3:1.

In another particular embodiment, a beverage comprises (i) a steviol glycoside mixture comprising rebaudioside M in a concentration from about 1 ppm to about 250 ppm and (ii) at least one synthetic sweetener in a concentration from about 1 ppm to about 250 ppm.

In a further particular embodiment, a beverage comprises (i) a steviol glycoside mixture comprising rebaudioside M in a concentration from about 1 ppm to about 250 ppm and (ii) at least one synthetic sweetener in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1.

In a more particular embodiment, a beverage comprises (i) a steviol glycoside mixture comprising rebaudioside M in a concentration from about 1 ppm to about 250 ppm; (ii) at least one synthetic sweetener selected from the group consisting of sucralose, acesulfame K and saccharin in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1.

For example, a beverage comprises (i) rebaudioside M in a concentration from about 1 ppm to about 250 ppm and (ii) sucralose in a concentration from about 1 ppm to about 250 ppm. In a more particular embodiment, the beverage is a carbonated beverage and the concentration of rebaudioside M is from about 75 ppm to about 150 ppm and the concentration of sucralose is from about 75 ppm to about 100 ppm. In another embodiment, the beverage is a plant protein-containing beverage and concentration of rebaudioside M is from about 30 ppm to about 70 ppm and the concentration of sucralose is from about 10 ppm to about 50 ppm or about 50 ppm to about 150 ppm.

In another example, a beverage comprises (i) rebaudioside M in a concentration from about 1 ppm to about 250 ppm and (ii) acesulfame K in a concentration from about 1 ppm to about 250 ppm. In a more particular embodiment, the beverage is a carbonated beverage and the concentration of rebaudioside M is from about 150 ppm to about 250 ppm and the concentration of acesulfame K is from about 150 ppm to about 250 ppm.

In yet another example, a beverage comprises (i) rebaudioside M in a concentration from about 1 ppm to about 250 ppm and (ii) saccharin in a concentration from about 1 ppm to about 250 ppm. In a more particular embodiment, the beverage is a carbonated beverage and the concentration of rebaudioside M is from about 150 ppm to about 250 ppm and the concentration of saccharine is from about 100 ppm to about 200 ppm.

It has also been found that addition of erythritol, allulose, cellobiose, hesperetin dihydrochalcone-4′-O-β-D-glucoside and/or phloretin further improves the sensory profiles of the beverages. Accordingly, the beverages of the present invention can further comprise one or more substances selected from the group consisting of erythritol, allulose, cellobiose, hesperetin dihydrochalcone-4′-O-β-D-glucoside and phloretin.

The concentration of erythritol, allulose and cellobiose in the beverage can vary. In one embodiment, a beverage of the present invention comprises at least one of erythritol, allulose and/or cellobiose in an amount from about 0.1% to about 2% by weight, such as for example, from about 0.5% to about 2% by weight, from about 0.5% to about 1% by weight or from about 1% to about 2% by weight. In a particular embodiment, a beverage comprises erythritol in an amount from about 0.1% to about 2% by weight, such as for example, from about 0.5% to about 2% by weight, from about 0.5% to about 1% by weight or from about 1% to about 2% by weight. In another particular embodiment, a beverage comprises allulose in an amount from about 0.1% to about 2% by weight, such as for example, from about 0.5% to about 2% by weight, from about 0.5% to about 1% by weight or from about 1% to about 2% by weight. In still another particular embodiment, a beverage comprises cellobiose in an amount from about 0.1% to about 2% by weight, such as for example, from about 0.5% to about 2% by weight, from about 0.5% to about 1% by weight or from about 1% to about 2% by weight.

The concentration of phloretin in the beverage can also vary. In one embodiment, a beverage of the present invention comprises phloretin in a concentration from about 0.1 ppm to about 15 ppm, such as, for example, from about 0.1 ppm to about 10 ppm, from about 0.1 ppm to about 5 ppm, from about 0.1 ppm to about 3 ppm, from about 1 ppm to about 15 ppm, from about 1 ppm to about 10 ppm, from about 1 ppm to about 5 ppm, from about 1 ppm to about 3 ppm, from about 3 ppm to about 15 ppm, from about 3 ppm to about 10 ppm, from about 3 ppm to about 5 ppm, from about 5 ppm to about 15 ppm, from about 5 ppm to about 10 ppm and from about 10 ppm to about 15.

The concentration of hesperetin dihydrochalcone-4′-O-β-D-glucoside in the beverage can also vary. In one embodiment, a beverage of the present invention comprises hesperetin dihydrochalcone-4′-O-β-D-glucoside in a concentration from about 0.1 ppm to about 20 ppm, such as, for example, from about 0.1 to about 15 ppm, from about 0.1 ppm to about 10 ppm, from about 0.1 ppm to about 5 ppm, from about 1 ppm to about 20 ppm, from about 1 ppm to about 15 ppm, from about 1 ppm to about 10 ppm, from about 1 ppm to about 5 ppm, from about 5 ppm to about 20 ppm, from about 5 ppm to about 15 ppm, from about 5 ppm to about 10 ppm, from about 10 ppm to about 20 ppm, from about 10 ppm to about 15 ppm and from about 15 ppm to about 20 ppm.

In another embodiment, a beverage comprises (i) a steviol glycoside mixture comprising rebaudioside M, (ii) at least one synthetic sweetener, wherein the weight ratio of the steviol glycoside comprising rebaudioside M to at least one synthetic sweetener is from about 0.5:1 to about 3:1, such as, for example from 1:1 to about 2:1, and (iii) erythritol.

In another more particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm and (iii) erythritol in an amount from about 0.1% to about 2% by weight.

In a still further particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1, and (iii) erythritol in an amount from about 0.1% to about 2% by weight.

In a yet further particular embodiment, a beverage comprises (i) rebaudioside M in a concentration from about 1 ppm to about 250 ppm, (ii) sucralose in a concentration from about 1 ppm to about 250 ppm and (iii) erythritol in an amount from about 0.1% to about 2% by weight. In a more particular embodiment, the concentration of rebaudioside M is from about 75 ppm to about 150 ppm, the concentration of sucralose is from about 75 ppm to about 100 ppm and erythritol is present in an amount from about 0.1% to about 2% by weight.

In another yet further particular embodiment, a beverage comprises (i) rebaudioside M in a concentration from about 1 ppm to about 250 ppm, (ii) acesulfame K in a concentration from about 1 ppm to about 250 ppm and (iii) erythritol in an amount from about 0.1% to about 2% by weight. In a more particular embodiment, the concentration of rebaudioside M is from about 150 ppm to about 250 ppm, the concentration of acesulfame K is from about 150 ppm to about 250 ppm and erythritol is present in an amount from about 0.1% to about 2% by weight.

In still another yet further particular embodiment, a beverage comprises (i) rebaudioside M in a concentration from about 1 ppm to about 250 ppm, (ii) saccharin in a concentration from about 1 ppm to about 250 ppm and (iii) erythritol in an amount from about 0.1% to about 2% by weight. In a more particular embodiment, the concentration of rebaudioside M is from about 150 ppm to about 250 ppm, the concentration of saccharine is from about 100 ppm to about 200 ppm and erythritol is present in an amount from about 0.1% to about 2% by weight.

In another embodiment, a beverage comprises (i) a steviol glycoside mixture comprising rebaudioside M, (ii) at least one synthetic sweetener, wherein the weight ratio of the steviol glycoside comprising rebaudioside M to at least one synthetic sweetener is from about 0.5:1 to about 3:1, such as, for example from 1:1 to about 2:1, and (iii) allulose.

In another more particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm and (iii) allulose in an amount from about 0.1% to about 2% by weight.

In a still further particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1, and (iii) allulose in an amount from about 0.1% to about 2% by weight.

In another embodiment, a beverage comprises (i) a steviol glycoside mixture comprising rebaudioside M, (ii) at least one synthetic sweetener, wherein the weight ratio of the steviol glycoside comprising rebaudioside M to at least one synthetic sweetener is from about 0.5:1 to about 3:1, such as, for example from about 1:1 to about 2:1, and (iii) cellobiose.

In another more particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm and (iii) cellobiose in an amount from about 0.1% to about 2% by weight.

In a still further particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1, and (iii) cellobiose in an amount from about 0.1% to about 2% by weight.

In another embodiment, a beverage comprises (i) a steviol glycoside mixture comprising rebaudioside M, (ii) at least one synthetic sweetener, wherein the weight ratio of the steviol glycoside comprising rebaudioside M to at least one synthetic sweetener is from about 0.5:1 to about 3:1, such as, for example from 1:1 to about 2:1, and (iii) hesperetin dihydrochalcone-4′-O-β-D-glucoside.

In another more particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm and (iii) hesperetin dihydrochalcone-4′-O-β-D-glucoside in a concentration from about 0.1 ppm to about 20 ppm.

In a still further particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1, and (iii) hesperetin dihydrochalcone-4′-O-β-D-glucoside in a concentration from about 0.1 ppm to about 20 ppm.

In another embodiment, a beverage comprises (i) a steviol glycoside mixture comprising rebaudioside M, (ii) at least one synthetic sweetener, wherein the weight ratio of the steviol glycoside comprising rebaudioside M to at least one synthetic sweetener is from about 0.5:1 to about 3:1, such as, for example from 1:1 to about 2:1, and (iii) phloretin.

In a more particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm and (iii) phloretin in a concentration from about 0.1 ppm to about 15 ppm.

In a still further particular embodiment, a beverage comprises (i) a steviol glycoside mixture comprising rebaudioside M in a concentration from about 1 ppm to about 250 ppm, (ii) at least one synthetic sweetener in a concentration from about 1 ppm to about 250 ppm, wherein the weight ratio of the steviol glycoside comprising rebaudioside M to at least one synthetic sweetener is from about 0.5:1 to about 3:1, such as, for example from 1:1 to about 2:1, and (iii) phloretin in a concentration from about 0.1 ppm to about 15 ppm.

In a yet further particular embodiment, a beverage comprises (i) rebaudioside M in a concentration from about 1 ppm to about 250 ppm, (ii) sucralose in a concentration from about 1 ppm to about 250 ppm and (iii) phloretin in a concentration from about 0.1 ppm to about 15 ppm. In a more particular embodiment, the concentration of rebaudioside M is from about 75 ppm to about 150 ppm, the concentration of sucralose is from about 75 ppm to about 100 ppm and the concentration of phloretin is from about 0.1 ppm to about 1 ppm.

In another yet further particular embodiment, a beverage comprises (i) rebaudioside M in a concentration from about 1 ppm to about 250 ppm, (ii) acesulfame K in a concentration from about 1 ppm to about 250 ppm and (iii) phloretin in a concentration from about 0.1 ppm to about 15 ppm. In a more particular embodiment, the concentration of rebaudioside M is from about 150 ppm to about 250 ppm, the concentration of acesulfame K is from about 150 ppm to about 250 ppm and the concentration of phloretin is from about 0.1 ppm to about 1 ppm.

In still another yet further particular embodiment, a beverage comprises (i) rebaudioside M in a concentration from about 1 ppm to about 250 ppm, (ii) saccharin in a concentration from about 1 ppm to about 250 ppm and (iii) phloretin in a concentration from about 0.1 ppm to about 15 ppm. In a more particular embodiment, the concentration of rebaudioside M is from about 150 ppm to about 250 ppm, the concentration of saccharine is from about 100 ppm to about 200 ppm and the concentration of phloretin is from about 0.1 ppm to about 1 ppm.

The beverages of the present invention can contain additional typical beverage ingredients, e.g. at least one functional ingredient and/or at least one additive, described hereinbelow.

In some embodiments, the sweetener blend of the present invention is the only sweetener, i.e. the only substance that provides detectable sweetness to the beverage.

A method of preparing a beverage comprises mixing a beverage syrup described herein with an appropriate quantity of diluting water.

Typically, the volumetric ratio of syrup to water is between 1:3 to 1:8, such as, for example, between 1:3 and 1:8, between 1:3 and 1:7, between 1:3 and 1:6, between 1:3 and 1:5, between 1:3 and 1:4, between 1:4 and 1:8, between 1:4 and 1:7, between 1:4 and 1:6, between 1:4 and 1:5, between 1:5 and 1:8, between 1:5 and 1:7, between 1:5 and 1:6, between 1:6 and 1:8, between 1:6 and 1:7 and between 1:7 and 1:8. In a particular embodiment, the volumetric ratio of syrup to water is about 1:5.5.

The temperature at which the mixing is done is preferably under about 70° C. to minimize degradation of steviol glycosides, more preferably room temperature.

In one embodiment, the beverage is a carbonated beverage (e.g. fountain drink or soft drink) and the diluting water is carbonated water. The beverage is typically dispensed for immediate consumption.

Other types of water typical in beverage manufacturing and be used to prepare beverages, e.g. deionized water, distilled water, reverse osmosis water, carbon-treated water, purified water, demineralized water and combinations thereof.

In another embodiment, a method of preparing a ready-to-drink beverage comprises (i) providing a beverage matrix and (ii) adding the beverage ingredients described hereinabove to the beverage matrix, thereby providing a ready-to-drink beverage. The method optionally includes a further mixing step whereby the beverage ingredients and matrix are mixed to promote dissolution. The method can also optionally include a heating step, whereby the beverage ingredients and matrix are heated to promote dissolution.

Beverage ingredients are dissolved in the beverage matrix. Exemplary beverage matrices include water of beverage quality, for example deionized water, distilled water, reverse osmosis water, carbon-treated water, purified water, demineralized water and combinations thereof. Additional suitable matrices include, but are not limited to phosphoric acid, phosphate buffer, citric acid, citrate buffer and carbon-treated water.

The method can be performed at any temperature required to formulate the ready-to-drink beverage. For example, for ingredients that are temperature sensitive, the method is carried out below 70° C. Similarly, the beverage ingredients can be added to the beverage matrix in any order.

### IV. Functional Ingredients and Additives

Exemplary functional ingredients include, but are not limited to, saponins, antioxidants, dietary fiber sources, fatty acids, vitamins, glucosamine, minerals, preservatives, hydration agents, probiotics, prebiotics, post biotics, weight management agents, digestive health ingredients, osteoporosis management agents, phytoestrogens, long chain primary aliphatic saturated alcohols, phytosterols, mental acuity and beauty agents and combinations thereof.

In certain embodiments, the functional ingredient is at least one saponin. As used herein, the at least one saponin may comprise a single saponin or a plurality of saponins as a functional ingredient for the composition provided herein. Saponins are glycosidic natural plant products comprising an aglycone ring structure and one or more sugar moieties. Non-limiting examples of specific saponins for use in particular embodiments of the invention include group A acetyl saponin, group B acetyl saponin, and group E acetyl saponin. Several common sources of saponins include soybeans, which have approximately 5% saponin content by dry weight, soapwort plants (Saponaria), the root of which was used historically as soap, as well as alfalfa, aloe, asparagus, grapes, chickpeas, yucca, and various other beans and weeds. Saponins may be obtained from these sources by using extraction techniques well known to those of ordinary skill in the art. A description of conventional extraction techniques can be found in U.S. Pat. Appl. No. 2005/0123662.

In certain embodiments, the functional ingredient is at least one antioxidant. As used herein, “antioxidant” refers to any substance which inhibits, suppresses, or reduces oxidative damage to cells and biomolecules.

Examples of suitable antioxidants for embodiments of this invention include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, α-carotene, β-carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme Q10, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-α-lipoic acid, N-acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example. Other sources of suitable antioxidants for embodiments of this invention include, but are not limited to, fruits, vegetables, tea, cocoa, chocolate, spices, herbs, rice, organ meats from livestock, yeast, whole grains, or cereal grains.

Particular antioxidants belong to the class of phytonutrients called polyphenols (also known as “polyphenolics”), which are a group of chemical substances found in plants, characterized by the presence of more than one phenol group per molecule. Suitable polyphenols for embodiments of this invention include catechins, proanthocyanidins, procyanidins, anthocyanins, quercerin, rutin, reservatrol, isoflavones, curcumin, punicalagin, ellagitannin, hesperidin, naringin, citrus flavonoids, chlorogenic acid, other similar materials, and combinations thereof.

In one embodiment, the antioxidant is a catechin such as, for example, epigallocatechin gallate (EGCG). In another embodiment, the antioxidant is chosen from proanthocyanidins, procyanidins or combinations thereof. In particular embodiments, the antioxidant is an anthocyanin. In still other embodiments, the antioxidant is chosen from quercetin, rutin or combinations thereof. In one embodiment, the antioxidant is reservatrol. In another embodiment, the antioxidant is an isoflavone. In still another embodiment, the antioxidant is curcumin. In a yet further embodiment, the antioxidant is chosen from punicalagin, ellagitannin or combinations thereof. In a still further embodiment, the antioxidant is chlorogenic acid.

In certain embodiments, the functional ingredient is at least one dietary fiber. Numerous polymeric carbohydrates having significantly different structures in both composition and linkages fall within the definition of dietary fiber. Such compounds are well known to those skilled in the art, non-limiting examples of which include non-starch polysaccharides, lignin, cellulose, methylcellulose, the hemicelluloses, β-glucans, pectins, gums, mucilage, waxes, inulins, oligosaccharides, fructooligosaccharides, cyclodextrins, chitins, and combinations thereof. Although dietary fiber generally is derived from plant sources, indigestible animal products such as chitins are also classified as dietary fiber. Chitin is a polysaccharide composed of units of acetylglucosamine joined by β(1-4) linkages, similar to the linkages of cellulose.

In certain embodiments, the functional ingredient is at least one fatty acid. As used herein, “fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, Md.), OmegaPure (from Omega Protein, Houston, Tex.), Marinol C-38 (from Lipid Nutrition, Channahon, Ill.), Bonito oil and MEG-3 (from Ocean Nutrition, Dartmouth, NS), Evogel (from Symrise, Holzminden, Germany), Marine Oil, from tuna or salmon (from Arista Wilton, Conn.), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

In certain embodiments, the functional ingredient is at least one vitamin. Suitable vitamins include, vitamin A, vitamin D, vitamin E, vitamin K, vitamin B1, vitamin B2, vitamin B3, vitamin B5, vitamin B6, vitamin B7, vitamin B9, vitamin B12, and vitamin C.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins. In some embodiments, the vitamin is a fat-soluble vitamin chosen from vitamin A, D, E, K and combinations thereof. In other embodiments, the vitamin is a water-soluble vitamin chosen from vitamin B1, vitamin B2, vitamin B3, vitamin B6, vitamin B12, folic acid, biotin, pantothenic acid, vitamin C and combinations thereof.

In certain embodiments, the functional ingredient is glucosamine, optionally further comprising chondroitin sulfate.

In certain embodiments, the functional ingredient is at least one mineral. Minerals, in accordance with the teachings of this invention, comprise inorganic chemical elements required by living organisms. Minerals are comprised of a broad range of compositions (e.g., elements, simple salts, and complex silicates) and also vary broadly in crystalline structure. They may naturally occur in foods and beverages, may be added as a supplement, or may be consumed or administered separately from foods or beverages.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In one embodiment, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In a particular embodiment, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in one embodiment, the minerals may be in their ionic form, having either a positive or negative charge. In another embodiment, the minerals may be in their molecular form. For example, sulfur and phosphorous often are found naturally as sulfates, sulfides, and phosphates.

In certain embodiments, the functional ingredient is at least one preservative. In particular embodiments, the preservative is chosen from antimicrobials, antioxidants, antienzymatics or combinations thereof. Non-limiting examples of antimicrobials include sulfites, propionates, benzoates, sorbates, nitrates, nitrites, bacteriocins, salts, sugars, acetic acid, dimethyl dicarbonate (DMIDC), ethanol, and ozone. In one embodiment, the preservative is a sulfite. Sulfites include, but are not limited to, sulfur dioxide, sodium bisulfite, and potassium hydrogen sulfite. In another embodiment, the preservative is a propionate. Propionates include, but are not limited to, propionic acid, calcium propionate, and sodium propionate. In yet another embodiment, the preservative is a benzoate. Benzoates include, but are not limited to, sodium benzoate and benzoic acid. In still another embodiment, the preservative is a sorbate. Sorbates include, but are not limited to, potassium sorbate, sodium sorbate, calcium sorbate, and sorbic acid. In a still further embodiment, the preservative is a nitrate and/or a nitrite. Nitrates and nitrites include, but are not limited to, sodium nitrate and sodium nitrite. In another embodiment, the at least one preservative is a bacteriocin, such as, for example, nisin. In still another embodiment, the preservative is ethanol. In yet another embodiment, the preservative is ozone. Non-limiting examples of antienzymatics suitable for use as preservatives in particular embodiments of the invention include ascorbic acid, citric acid, and metal chelating agents such as ethylenediaminetetraacetic acid (EDTA).

In certain embodiments, the functional ingredient is at least one hydration agent. In another particular embodiment, the hydration agent is a carbohydrate to supplement energy stores burned by muscles. Suitable carbohydrates for use in particular embodiments of this invention are described in U.S. Pat. Nos. 4,312,856, 4,853,237, 5,681,569, and 6,989,171. Non-limiting examples of suitable carbohydrates include monosaccharides, disaccharides, oligosaccharides, complex polysaccharides or combinations thereof. Non-limiting examples of suitable types of monosaccharides for use in particular embodiments include trioses, tetroses, pentoses, hexoses, heptoses, octoses, and nonoses. Non-limiting examples of specific types of suitable monosaccharides include glyceraldehyde, dihydroxyacetone, erythrose, threose, erythrulose, arabinose, lyxose, ribose, xylose, ribulose, xylulose, allose, altrose, galactose, glucose, gulose, idose, mannose, talose, fructose, psicose, sorbose, tagatose, mannoheptulose, sedoheltulose, octolose, and sialose. Non-limiting examples of suitable disaccharides include sucrose, lactose, and maltose. Non-limiting examples of suitable oligosaccharides include saccharose, maltotriose, and maltodextrin. In other particular embodiments, the carbohydrates are provided by a corn syrup, a beet sugar, a cane sugar, a juice, or a tea.

In another particular embodiment, the hydration agent is a flavanol that provides cellular rehydration. Flavanols are a class of natural substances present in plants, and generally comprise a 2-phenylbenzopyrone molecular skeleton attached to one or more chemical moieties. Non-limiting examples of suitable flavanols for use in particular embodiments of this invention include catechin, epicatechin, gallocatechin, epigallocatechin, epicatechin gallate, epigallocatechin 3-gallate, theaflavin, theaflavin 3-gallate, theaflavin 3′-gallate, theaflavin 3,3′ gallate, thearubigin or combinations thereof. Several common sources of flavanols include tea plants, fruits, vegetables, and flowers. In preferred embodiments, the flavanol is extracted from green tea.

In a particular embodiment, the hydration agent is a glycerol solution to enhance exercise endurance. The ingestion of a glycerol containing solution has been shown to provide beneficial physiological effects, such as expanded blood volume, lower heart rate, and lower rectal temperature.

In certain embodiments, the functional ingredient is chosen from at least one probiotic, prebiotic and combination thereof. The probiotic is a beneficial microorganism that affects the human body's naturally-occurring gastrointestinal microflora. Examples of probiotics include, but are not limited to, bacteria of the genus Lactobacilli, Bifidobacteria, Streptococci, or combinations thereof, that confer beneficial effects to humans. In particular embodiments of the invention, the at least one probiotic is chosen from the genus Lactobacilli. According to other particular embodiments of this invention, the probiotic is chosen from the genus Bifidobacteria. In a particular embodiment, the probiotic is chosen from the genus Streptococcus.

Probiotics that may be used in accordance with this invention are well-known to those of skill in the art. Non-limiting examples of foodstuffs comprising probiotics include yogurt, sauerkraut, kefir, kimchi, fermented vegetables, and other foodstuffs containing a microbial element that beneficially affects the host animal by improving the intestinal microbalance.

Prebiotics, in accordance with the embodiments of this invention, include, without limitation, mucopolysaccharides, oligosaccharides, polysaccharides, amino acids, vitamins, nutrient precursors, proteins and combinations thereof. According to a particular embodiment of this invention, the prebiotic is chosen from dietary fibers, including, without limitation, polysaccharides and oligosaccharides. Non-limiting examples of oligosaccharides that are categorized as prebiotics in accordance with particular embodiments of this invention include fructooligosaccharides, inulins, isomalto-oligosaccharides, lactilol, lactosucrose, lactulose, pyrodextrins, soy oligosaccharides, transgalacto-oligosaccharides, and xylo-oligosaccharides. In other embodiments, the prebiotic is an amino acid. Although a number of known prebiotics break down to provide carbohydrates for probiotics, some probiotics also require amino acids for nourishment.

Prebiotics are found naturally in a variety of foods including, without limitation, bananas, berries, asparagus, garlic, wheat, oats, barley (and other whole grains), flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

In certain embodiments, the functional ingredient is at least one weight management agent. As used herein, “a weight management agent” includes an appetite suppressant and/or a thermogenesis agent. As used herein, the phrases “appetite suppressant”, “appetite satiation compositions”, “satiety agents”, and “satiety ingredients” are synonymous. The phrase “appetite suppressant” describes macronutrients, herbal extracts, exogenous hormones, anorectics, anorexigenics, pharmaceutical drugs, and combinations thereof, that when delivered in an effective amount, suppress, inhibit, reduce, or otherwise curtail a person's appetite. The phrase “thermogenesis agent” describes macronutrients, herbal extracts, exogenous hormones, anorectics, anorexigenics, pharmaceutical drugs, and combinations thereof, that when delivered in an effective amount, activate or otherwise enhance a person's thermogenesis or metabolism.

Suitable weight management agents include macronutrients selected from the group consisting of proteins, carbohydrates, dietary fats, and combinations thereof. Consumption of proteins, carbohydrates, and dietary fats stimulates the release of peptides with appetite-suppressing effects. For example, consumption of proteins and dietary fats stimulates the release of the gut hormone cholecytokinin (CCK), while consumption of carbohydrates and dietary fats stimulates release of Glucagon-like peptide 1 (GLP-1).

Suitable macronutrient weight management agents also include carbohydrates. Carbohydrates generally comprise sugars, starches, cellulose and gums that the body converts into glucose for energy. Carbohydrates often are classified into two categories, digestible carbohydrates (e.g., monosaccharides, disaccharides, and starch) and non-digestible carbohydrates (e.g., dietary fiber). Studies have shown that non-digestible carbohydrates and complex polymeric carbohydrates having reduced absorption and digestibility in the small intestine stimulate physiologic responses that inhibit food intake. Accordingly, the carbohydrates embodied herein desirably comprise non-digestible carbohydrates or carbohydrates with reduced digestibility. Non-limiting examples of such carbohydrates include polydextrose; inulin; monosaccharide-derived polyols such as erythritol, mannitol, xylitol, and sorbitol; disaccharide-derived alcohols such as isomalt, lactitol, and maltitol; and hydrogenated starch hydrolysates. Carbohydrates are described in more detail herein below.

In another particular embodiment, the weight management agent is a dietary fat. Dietary fats are lipids comprising combinations of saturated and unsaturated fatty acids. Polyunsaturated fatty acids have been shown to have a greater satiating power than mono-unsaturated fatty acids. Accordingly, the dietary fats embodied herein desirably comprise poly-unsaturated fatty acids, non-limiting examples of which include triacylglycerols.

In another particular embodiment, the weight management agent is an herbal extract. Extracts from numerous types of plants have been identified as possessing appetite suppressant properties. Non-limiting examples of plants whose extracts have appetite suppressant properties include plants of the genus Hoodia, Trichocaulon, Caralluma, Stapelia, Orbea, Asclepias, and Camelia. Other embodiments include extracts derived from Gymnema Sylvestre, Kola Nut, Citrus Auran tium, Yerba Mate, Griffonia Simplicifolia, Guarana, myrrh, guggul Lipid, and black current seed oil.

The herbal extracts may be prepared from any type of plant material or plant biomass. Non-limiting examples of plant material and biomass include the stems, roots, leaves, dried powder obtained from the plant material, and sap or dried sap. The herbal extracts generally are prepared by extracting sap from the plant and then spray-drying the sap. Alternatively, solvent extraction procedures may be employed. Following the initial extraction, it may be desirable to further fractionate the initial extract (e.g., by column chromatography) in order to obtain an herbal extract with enhanced activity. Such techniques are well known to those of ordinary skill in the art.

In one embodiment, the herbal extract is derived from a plant of the genus Hoodia. A sterol glycoside of Hoodia, known as P57, is believed to be responsible for the appetite-suppressant effect of the Hoodia species. In another embodiment, the herbal extract is derived from a plant of the genus Caralluma, non-limiting examples of which include caratuberside A, caratuberside B, bouceroside I, bouceroside II, bouceroside III, bouceroside IV, bouceroside V, bouceroside VI, bouceroside VII, bouceroside VIII, bouceroside IX, and bouceroside X. In another embodiment, the at least one herbal extract is derived from a plant of the genus Trichocaulon. Trichocaulon plants are succulents that generally are native to southern Africa, similar to Hoodia, and include the species T. piliferum and T officinale. In another embodiment, the herbal extract is derived from a plant of the genus Stapelia or Orbea. Not wishing to be bound by any theory, it is believed that the compounds exhibiting appetite suppressant activity are saponins, such as pregnane glycosides, which include stavarosides A, B, C, D, E, F, G, H, I, J, and K. In another embodiment, the herbal extract is derived from a plant of the genus Asclepias. Not wishing to be bound by any theory, it is believed that the extracts comprise steroidal compounds, such as pregnane glycosides and pregnane aglycone, having appetite suppressant effects.

In another particular embodiment, the weight management agent is an exogenous hormone having a weight management effect. Non-limiting examples of such hormones include CCK, peptide YY, ghrelin, bombesin and gastrin-releasing peptide (GRP), enterostatin, apolipoprotein A-IV, GLP-1, amylin, somastatin, and leptin.

In another embodiment, the weight management agent is a pharmaceutical drug. Non-limiting examples include phentenime, diethylpropion, phendimetrazine, sibutramine, rimonabant, oxyntomodulin, floxetine hydrochloride, ephedrine, phenethylamine, or other stimulants.

In certain embodiments, the functional ingredient is at least one osteoporosis management agent. In certain embodiments, the osteoporosis management agent is at least one calcium source. According to a particular embodiment, the calcium source is any compound containing calcium, including salt complexes, solubilized species, and other forms of calcium. Non-limiting examples of calcium sources include amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium citrate malate, calcium gluconate, calcium tartrate, calcium lactate, solubilized species thereof, and combinations thereof.

According to a particular embodiment, the osteoporosis management agent is a magnesium source. The magnesium source is any compound containing magnesium, including salt complexes, solubilized species, and other forms of magnesium. Non-limiting examples of magnesium sources include magnesium chloride, magnesium citrate, magnesium gluceptate, magnesium gluconate, magnesium lactate, magnesium hydroxide, magnesium picolate, magnesium sulfate, solubilized species thereof, and mixtures thereof. In another particular embodiment, the magnesium source comprises an amino acid chelated or creatine chelated magnesium.

In other embodiments, the osteoporosis agent is chosen from vitamins D, C, K, their precursors and/or beta-carotene and combinations thereof.

Numerous plants and plant extracts also have been identified as being effective in the prevention and treatment of osteoporosis. Non-limiting examples of suitable plants and plant extracts as osteoporosis management agents include species of the genus Taraxacum and Amelanchier, as disclosed in U.S. Patent Publication No. 2005/0106215, and species of the genus Lindera, Artemisia, Acorus, Carthamus, Carum, Cnidium, Curcuma, Cyperus, Juniperus, Prunus, Iris, Cichorium, Dodonaea, Epimedium, Erigonoum, Soya, Mentha, Ocimum, thymus, Tanacetum, Plantago, Spearmint, Bixa, Vitis, Rosemarinus, Rhus, and Anethum, as disclosed in U.S. Patent Publication No. 2005/0079232.

In certain embodiments, the functional ingredient is at least one phytoestrogen. Phytoestrogens are compounds found in plants which can typically be delivered into human bodies by ingestion of the plants or the plant parts having the phytoestrogens. As used herein, “phytoestrogen” refers to any substance which, when introduced into a body causes an estrogen-like effect of any degree. For example, a phytoestrogen may bind to estrogen receptors within the body and have a small estrogen-like effect.

Examples of suitable phytoestrogens for embodiments of this invention include, but are not limited to, isoflavones, stilbenes, lignans, resorcyclic acid lactones, coumestans, coumestrol, equol, and combinations thereof. Sources of suitable phytoestrogens include, but are not limited to, whole grains, cereals, fibers, fruits, vegetables, black cohosh, agave root, black currant, black haw, chasteberries, cramp bark, dong quai root, devil's club root, false unicorn root, ginseng root, groundsel herb, licorice, liferoot herb, motherwort herb, peony root, raspberry leaves, rose family plants, sage leaves, sarsaparilla root, saw palmetto berried, wild yam root, yarrow blossoms, legumes, soybeans, soy products (e.g., miso, soy flour, soymilk, soy nuts, soy protein isolate, tempen, or tofu) chick peas, nuts, lentils, seeds, clover, red clover, dandelion leaves, dandelion roots, fenugreek seeds, green tea, hops, red wine, flaxseed, garlic, onions, linseed, borage, butterfly weed, caraway, chaste tree, vitex, dates, dill, fennel seed, gotu kola, milk thistle, pennyroyal, pomegranates, southernwood, soya flour, tansy, and root of the kudzu vine (pueraria root) and the like, and combinations thereof.

Isoflavones belong to the group of phytonutrients called polyphenols. In general, polyphenols (also known as “polyphenolics”), are a group of chemical substances found in plants, characterized by the presence of more than one phenol group per molecule.

Suitable phytoestrogen isoflavones in accordance with embodiments of this invention include genistein, daidzein, glycitein, biochanin A, formononetin, their respective naturally occurring glycosides and glycoside conjugates, matairesinol, secoisolariciresinol, enterolactone, enterodiol, textured vegetable protein, and combinations thereof.

Suitable sources of isoflavones for embodiments of this invention include, but are not limited to, soy beans, soy products, legumes, alfalfa sprouts, chickpeas, peanuts, and red clover.

In certain embodiments, the functional ingredient is at least one long chain primary aliphatic saturated alcohol. Long-chain primary aliphatic saturated alcohols are a diverse group of organic compounds. The term alcohol refers to the fact these compounds feature a hydroxyl group (—OH) bound to a carbon atom. Non-limiting examples of particular long-chain primary aliphatic saturated alcohols for use in particular embodiments of the invention include the 8 carbon atom 1-octanol, the 9 carbon 1-nonanol, the 10 carbon atom 1-decanol, the 12 carbon atom 1-dodecanol, the 14 carbon atom 1-tetradecanol, the 16 carbon atom 1-hexadecanol, the 18 carbon atom 1-octadecanol, the 20 carbon atom 1-eicosanol, the 22 carbon 1-docosanol, the 24 carbon 1-tetracosanol, the 26 carbon 1-hexacosanol, the 27 carbon 1-heptacosanol, the 28 carbon 1-octanosol, the 29 carbon 1-nonacosanol, the 30 carbon 1-triacontanol, the 32 carbon 1-dotriacontanol, and the 34 carbon 1-tetracontanol.

In one embodiment, the long-chain primary aliphatic saturated alcohol is a policosanol. Policosanol is the term for a mixture of long-chain primary aliphatic saturated alcohols composed primarily of 28 carbon 1-octanosol and 30 carbon 1-triacontanol, as well as other alcohols in lower concentrations such as 22 carbon 1-docosanol, 24 carbon 1-tetracosanol, 26 carbon 1-hexacosanol, 27 carbon 1-heptacosanol, 29 carbon 1-nonacosanol, 32 carbon 1-dotriacontanol, and 34 carbon 1-tetracontanol.

In certain embodiments, the functional ingredient is at least one phytosterol, phytostanol or combination thereof. As used herein, the phrases “stanol”, “plant stanol” and “phytostanol” are synonymous. Plant sterols and stanols are present naturally in small quantities in many fruits, vegetables, nuts, seeds, cereals, legumes, vegetable oils, bark of the trees and other plant sources. Sterols are a subgroup of steroids with a hydroxyl group at C-3. Generally, phytosterols have a double bond within the steroid nucleus, like cholesterol; however, phytosterols also may comprise a substituted side chain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. Non-limiting suitable phytosterols include, but are not limited to, 4-desmethyl sterols (e.g., β-sitosterol, campesterol, stigmasterol, brassicasterol, 22-dehydrobrassicasterol, and Δ5-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. Suitable phytostanols include, but are not limited to, β-sitostanol, campestanol, cycloartanol, and saturated forms of other triterpene alcohols.

Both phytosterols and phytostanols, as used herein, include the various isomers such as the α and β isomers. The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

Exemplary additives include, but not limited to, carbohydrates, polyols, amino acids and their corresponding salts, poly-amino acids and their corresponding salts, sugar acids and their corresponding salts, nucleotides, organic acids, inorganic acids, organic salts including organic acid salts and organic base salts, inorganic salts, bitter compounds, caffeine, flavorants and flavoring ingredients, astringent compounds, proteins or protein hydrolysates, surfactants, emulsifiers, plant extracts, flavonoids, alcohols, polymers and combinations thereof.

In one embodiment, the composition further comprises one or more polyols. The term “polyol”, as used herein, refers to a molecule that contains more than one hydroxyl group. A polyol may be a diol, triol, or a tetraol which contains 2, 3, and 4 hydroxyl groups respectively. A polyol also may contain more than 4 hydroxyl groups, such as a pentaol, hexaol, heptaol, or the like, which contain 5, 6, or 7 hydroxyl groups, respectively. Additionally, a polyol also may be a sugar alcohol, polyhydric alcohol, or polyalcohol which is a reduced form of carbohydrate, wherein the carbonyl group (aldehyde or ketone, reducing sugar) has been reduced to a primary or secondary hydroxyl group. Non-limiting examples of polyols in some embodiments include maltitol, mannitol, sorbitol, lactitol, xylitol, isomalt, propylene glycol, glycerol (glycerin), threitol, galactitol, palatinose, reduced isomalto-oligosaccharides, reduced xylo-oligosaccharides, reduced gentio-oligosaccharides, reduced maltose syrup, reduced glucose syrup, and sugar alcohols or any other carbohydrates capable of being reduced which do not adversely affect taste.

Suitable amino acid additives include, but are not limited to, aspartic acid, arginine, glycine, glutamic acid, proline, threonine, theanine, cysteine, cystine, alanine, valine, tyrosine, leucine, arabinose, trans-4-hydroxyproline, isoleucine, asparagine, serine, lysine, histidine, ornithine, methionine, carnitine, aminobutyric acid (α-, β-, and/or δ-isomers), glutamine, hydroxyproline, taurine, norvaline, sarcosine, and their salt forms such as sodium or potassium salts or acid salts. The amino acid additives also may be in the D- or L-configuration and in the mono-, di-, or tri-form of the same or different amino acids. Additionally, the amino acids may be α-, β-, γ- and/or δ-isomers if appropriate. Combinations of the foregoing amino acids and their corresponding salts (e.g., sodium, potassium, calcium, magnesium salts or other alkali or alkaline earth metal salts thereof, or acid salts) also are suitable additives in some embodiments. The amino acids may be natural or synthetic. The amino acids also may be modified. Modified amino acids refers to any amino acid wherein at least one atom has been added, removed, substituted, or combinations thereof (e.g., N-alkyl amino acid, N-acyl amino acid, or N-methyl amino acid). Non-limiting examples of modified amino acids include amino acid derivatives such as trimethyl glycine, N-methyl-glycine, and N-methyl-alanine. As used herein, modified amino acids encompass both modified and unmodified amino acids. As used herein, amino acids also encompass both peptides and polypeptides (e.g., dipeptides, tripeptides, tetrapeptides, and pentapeptides) such as glutathione and L-alanyl-L-glutamine. Suitable polyamino acid additives include poly-L-aspartic acid, poly-L-lysine (e.g., poly-L-α-lysine or poly-L-ε-lysine), poly-L-ornithine (e.g., poly-L-α-ornithine or poly-L-ε-ornithine), poly-L-arginine, other polymeric forms of amino acids, and salt forms thereof (e.g., calcium, potassium, sodium, or magnesium salts such as L-glutamic acid mono sodium salt). The poly-amino acid additives also may be in the D- or L-configuration. Additionally, the poly-amino acids may be α-, β-, γ-, δ-, and ε-isomers if appropriate. Combinations of the foregoing poly-amino acids and their corresponding salts (e.g., sodium, potassium, calcium, magnesium salts or other alkali or alkaline earth metal salts thereof or acid salts) also are suitable additives in some embodiments. The poly-amino acids described herein also may comprise co-polymers of different amino acids. The poly-amino acids may be natural or synthetic. The poly-amino acids also may be modified, such that at least one atom has been added, removed, substituted, or combinations thereof (e.g., N-alkyl poly-amino acid or N-acyl poly-amino acid). As used herein, poly-amino acids encompass both modified and unmodified poly-amino acids. For example, modified poly-amino acids include, but are not limited to, poly-amino acids of various molecular weights (MW), such as poly-L-α-lysine with a MW of 1,500, MW of 6,000, MW of 25,200, MW of 63,000, MW of 83,000, or MW of 300,000.

Suitable sugar acid additives include, but are not limited to, aldonic, uronic, aldaric, alginic, gluconic, glucuronic, glucaric, galactaric, galacturonic, and salts thereof (e.g., sodium, potassium, calcium, magnesium salts or other physiologically acceptable salts), and combinations thereof.

Suitable nucleotide additives include, but are not limited to, inosine monophosphate (“IMP”), guanosine monophosphate (“GMP”), adenosine monophosphate (“AMP”), cytosine monophosphate (CMP), uracil monophosphate (UMP), inosine diphosphate, guanosine diphosphate, adenosine diphosphate, cytosine diphosphate, uracil diphosphate, inosine triphosphate, guanosine triphosphate, adenosine triphosphate, cytosine triphosphate, uracil triphosphate, alkali or alkaline earth metal salts thereof, and combinations thereof. The nucleotides described herein also may comprise nucleotide-related additives, such as nucleosides or nucleic acid bases (e.g., guanine, cytosine, adenine, thymine, uracil).

Suitable organic acid additives include any compound which comprises a —COOH moiety, such as, for example, C2-C30 carboxylic acids, substituted hydroxyl C2-C30 carboxylic acids, butyric acid (ethyl esters), substituted butyric acid (ethyl esters), benzoic acid, substituted benzoic acids (e.g., 2,4-dihydroxybenzoic acid), substituted cinnamic acids, hydroxyacids, substituted hydroxybenzoic acids, anisic acid substituted cyclohexyl carboxylic acids, tannic acid, aconitic acid, lactic acid, tartaric acid, citric acid, isocitric acid, gluconic acid, glucoheptonic acids, adipic acid, hydroxycitric acid, malic acid, fruitaric acid (a blend of malic, fumaric, and tartaric acids), fumaric acid, maleic acid, succinic acid, chlorogenic acid, salicylic acid, creatine, caffeic acid, bile acids, acetic acid, ascorbic acid, alginic acid, erythorbic acid, polyglutamic acid, glucono delta lactone, and their alkali or alkaline earth metal salt derivatives thereof. In addition, the organic acid additives also may be in either the D- or L-configuration.

Suitable organic acid additive salts include, but are not limited to, sodium, calcium, potassium, and magnesium salts of all organic acids, such as salts of citric acid, malic acid, tartaric acid, fumaric acid, lactic acid (e.g., sodium lactate), alginic acid (e.g., sodium alginate), ascorbic acid (e.g., sodium ascorbate), benzoic acid (e.g., sodium benzoate or potassium benzoate), sorbic acid and adipic acid. The examples of the organic acid additives described optionally may be substituted with at least one group chosen from hydrogen, alkyl, alkenyl, alkynyl, halo, haloalkyl, carboxyl, acyl, acyloxy, amino, amido, carboxyl derivatives, alkylamino, dialkylamino, arylamino, alkoxy, aryloxy, nitro, cyano, sulfo, thiol, imine, sulfonyl, sulfenyl, sulfinyl, sulfamyl, carboxalkoxy, carboxamido, phosphonyl, phosphinyl, phosphoryl, phosphino, thioester, thioether, anhydride, oximino, hydrazino, carbamyl, phosphor or phosphonato. In particular embodiments, the organic acid additive is present in the sweetener composition in an amount effective to provide a concentration from about 10 ppm to about 5,000 ppm when present in a consumable, such as, for example, a beverage.

Suitable inorganic acid additives include, but are not limited to, phosphoric acid, phosphorous acid, polyphosphoric acid, hydrochloric acid, sulfuric acid, carbonic acid, sodium dihydrogen phosphate, and alkali or alkaline earth metal salts thereof (e.g., inositol hexaphosphate Mg/Ca).

Suitable bitter compound additives include, but are not limited to, caffeine, quinine, urea, bitter orange oil, naringin, quassia, and salts thereof.

Suitable flavorants and flavoring ingredient additives include, but are not limited to, vanillin, vanilla extract, mango extract, cinnamon, citrus, coconut, ginger, viridiflorol, almond, menthol (including menthol without mint), grape skin extract, and grape seed extract. “Flavorant” and “flavoring ingredient” are synonymous and can include natural or synthetic substances or combinations thereof. Flavorants also include any other substance which imparts flavor and may include natural or non-natural (synthetic) substances which are safe for human or animals when used in a generally accepted range. Non-limiting examples of proprietary flavorants include Döhler™ Natural Flavoring Sweetness Enhancer K14323 (Döhler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™ Freehold, N.J., U.S.A.), and Sucramask™ (Creative Research Management, Stockton, Calif., U.S.A.).

Suitable polymer additives include, but are not limited to, chitosan, pectin, pectic, pectinic, polyuronic, polygalacturonic acid, starch, food hydrocolloid or crude extracts thereof (e.g., gum acacia senegal (Fibergum™), gum acacia seyal, carageenan), poly-L-lysine (e.g., poly-L-α-lysine or poly-L-ε-lysine), poly-L-ornithine (e.g., poly-L-α-ornithine or poly-L-ε-ornithine), polypropylene glycol, polyethylene glycol, poly(ethylene glycol methyl ether), polyarginine, polyaspartic acid, polyglutamic acid, polyethylene imine, alginic acid, sodium alginate, propylene glycol alginate, and sodium polyethyleneglycolalginate, sodium hexametaphosphate and its salts, and other cationic polymers and anionic polymers.

Suitable protein or protein hydrolysate additives include, but are not limited to, bovine serum albumin (BSA), whey protein (including fractions or concentrates thereof such as 90% instant whey protein isolate, 34% whey protein, 50% hydrolyzed whey protein, and 80% whey protein concentrate), soluble rice protein, soy protein, protein isolates, protein hydrolysates, reaction products of protein hydrolysates, glycoproteins, and/or proteoglycans containing amino acids (e.g., glycine, alanine, serine, threonine, asparagine, glutamine, arginine, valine, isoleucine, leucine, norvaline, methionine, proline, tyrosine, hydroxyproline, and the like), collagen (e.g., gelatin), partially hydrolyzed collagen (e.g., hydrolyzed fish collagen), and collagen hydrolysates (e.g., porcine collagen hydrolysate).

Suitable surfactant additives include, but are not limited to, polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and other emulsifiers, and the like.

Suitable flavonoid additives are classified as flavonols, flavones, flavanones, flavan-3-ols, isoflavones, or anthocyanidins. Non-limiting examples of flavonoid additives include, but are not limited to, catechins (e.g., green tea extracts such as Polyphenon™ 60, Polyphenon™ 30, and Polyphenon™ 25 (Mitsui Norin Co., Ltd., Japan), polyphenols, rutins (e.g., enzyme modified rutin Sanmelin™ AO (San-fi Gen F.F.I., Inc., Osaka, Japan)), neohesperidin, naringin, neohesperidin dihydrochalcone, and the like.

Suitable alcohol additives include, but are not limited to, ethanol.

Suitable astringent compound additives include, but are not limited to, tannic acid, europium chloride (EuCl₃), gadolinium chloride (GdCl₃), terbium chloride (TbCl₃), alum, tannic acid, and polyphenols (e.g., tea polyphenols).

### EXAMPLES

### Example 1: Diet Cola Beverages Containing Reb M and Sucralose

The following ingredients (in grams) were used to make 1 liter of beverage:

TABLE 1

| | | | Beverage 2 | Beverage 3 |
|---|---|---|---|---|
| | | | Reb-M | Reb-M |
| | Control | Beverage 1 | 100 ppm + | 100 ppm + |
| | Sucralose | Reb-M | sucralose | sucralose |
| | 156 ppm + | 100 ppm + | 90 ppm + | 90 ppm + |
| | Ace-K | sucralose | 0.5 ppm | erythritol |
| Ingredients | 116 ppm) | 90 ppm | phloretin | 0.5% |
| Water | 997.03 | 997.11 | 997.11 | 992.11 |
| Phosphoric acid | 0.304 | 0.304 | 0.304 | 0.304 |
| (75%) | | | | |
| Citric acid | 0.095 | 0.095 | 0.095 | 0.095 |
| Caffeine | 0.076 | 0.076 | 0.076 | 0.076 |
| Caramel | 0.113 | 0.113 | 0.113 | 0.113 |
| Sodium benzoate | 0.087 | 0.087 | 0.087 | 0.087 |
| Potassium sorbate | 0.105 | 0.105 | 0.105 | 0.105 |
| Cola flavor | 1.918 | 1.918 | 1.918 | 1.918 |
| Rebaudioside M | — | 0.1 | 0.1 | 0.1 |
| Sucralose | 0.156 | 0.09 | 0.09 | 0.09 |
| Acesulfame-K | 0.116 | — | — | — |
| Phloretin | | — | 0.0005 | — |
| Erythritol | — | — | — | 5 |
| Total | 1000 g | 1000 g | 1000 g | 1000 g |

The diet cola beverages were carbonated in a carbonation tank with beverage grade carbon dioxide to a carbonation level of 3.8 volume, then filled in 300 ml glass bottles and aged over night at 35° C. The following day, the beverages were cooled to 4° C. then bench tasted.

In case of syrup, the above ingredients were dissolved in 153.85 gram of water (1 part). Then 846.17 grams of carbonated water (5.5 parts) was added to make the final beverage.

### Example 2: Diet Cola Beverages Containing Reb M and Acesulfame K

The following ingredients (in grams) were used to make 1 liter of beverage:

TABLE 2

| | | | Beverage 5 | Beverage 6 |
|---|---|---|---|---|
| | | | Reb-M | Reb-M |
| | Control | Beverage 4 | 250 ppm + | 250 ppm + |
| | Sucralose | Reb-M | Ace-K | Ace-K |
| | 156 ppm + | 250 ppm + | 200 ppm + | 200 ppm + |
| | Ace-K | Ace-K | 0.5 ppm | erythritol |
| Ingredients | 116 ppm) | 200 ppm | phloretin | 0.5% |
| Water | 997.03 | 996.85 | 996.85 | 991.85 |
| Phosphoric acid | 0.304 | 0.304 | 0.304 | 0.304 |
| (75%) | | | | |
| Citric acid | 0.095 | 0.095 | 0.095 | 0.095 |
| Caffeine | 0.076 | 0.076 | 0.076 | 0.076 |
| Caramel | 0.113 | 0.113 | 0.113 | 0.113 |
| Sodium benzoate | 0.087 | 0.087 | 0.087 | 0.087 |
| Potassium sorbate | 0.105 | 0.105 | 0.105 | 0.105 |
| Cola flavor | 1.918 | 1.918 | 1.918 | 1.918 |
| Rebaudioside M | — | 0.25 | 0.25 | 0.25 |
| Sucralose | 0.156 | — | — | — |
| Acesulfame-K | 0.116 | 0.2 | 0.2 | 0.2 |
| Phloretin | | — | 0.0005 | — |
| Erythritol | — | — | — | 5 |
| Total | 1000 g | 1000 g | 1000 g | 1000 g |

The diet cola beverages were carbonated in a carbonation tank with beverage grade carbon dioxide to a carbonation level of 3.8 volume, then filled in 300 ml glass bottles and aged over night at 35° C. The following day, the beverages were cooled to 4° C. and bench tasted.

In case of syrup, the above ingredients were dissolved in 153.85 gram of water (1 part). Then 846.17 grams of carbonated water (5.5 parts) was added to make the final beverage.

### Example 3: Diet Cola Beverages Containing Reb M and Saccharin

The following ingredients (in gram) were used to make 1 liter of beverage:

TABLE 3

| | | | Beverage 8 | |
|---|---|---|---|---|
| | | | Reb-M | Beverage 9 |
| | Control | Beverage 7 | 160 ppm + | Reb-M |
| | Sucralose | Reb-M | saccharin | 160 ppm + |
| | 156 ppm + | 160 ppm + | 140 ppm + | saccharin |
| | Ace-K | Saccharin | 0.5 ppm | 140 ppm + |
| Ingredients | 116 ppm) | 140 ppm | phloretin | erythritol 0.5% |
| Water | 997.03 | 997.002 | 997.002 | 992.002 |
| Phosphoric acid | 0.304 | 0.304 | 0.304 | 0.304 |
| (75%) | | | | |
| Citric acid | 0.095 | 0.095 | 0.095 | 0.095 |
| Caffeine | 0.076 | 0.076 | 0.076 | 0.076 |
| Caramel | 0.113 | 0.113 | 0.113 | 0.113 |
| Sodium benzoate | 0.087 | 0.087 | 0.087 | 0.087 |
| Potassium sorbate | 0.105 | 0.105 | 0.105 | 0.105 |
| Cola flavor | 1.918 | 1.918 | 1.918 | 1.918 |
| Rebaudioside M | — | 0.160 | 0.160 | 0.160 |
| Sucralose | 0.156 | | | |
| Acesulfame-K | 0.116 | — | — | — |
| Saccharin | — | 0.140 | 0.140 | 0.140 |
| Phloretin | — | — | 0.0005 | — |
| Erythritol | — | — | — | 5 |
| Total | 1000 g | 1000 g | 1000 g | 1000 g |

The diet cola beverages were carbonated in a carbonation tank with beverage grade carbon dioxide to a carbonation level of 3.8 volume, then filled in 300 ml glass bottles and aged over night at 35° C. The following day, the beverages were cooled to 4° C. and bench tasted.

In case of syrup, the above ingredients were dissolved in 153.85 gram of water (1 part). Then 846.17 grams of carbonated water (5.5 parts) was added to make the final beverage.

### Example 4: Sensory Test Results for the Beverages of Examples 1-3

Four experienced panelists bench tasted the beverages of Examples 1-3 blindly (3 sessions for carbonated beverages). Each panelist was given warm bottled water and unsalted crackers to eat and rinse the palate between samples. A maximum of 4 samples was tasted at each session to avoid fatigue.

TABLE 4
Sensory Taste Results for Diet Carbonated Cola

| BLEND | BEVERAGE | TASTE COMMENTS |
|---|---|---|
| | Control | Sweetness lingering, bitter/astringent |
| | | aftertaste |
| WITH | Beverage 1 | Less artificial, sugar-like taste, some |
| SUCRALOSE | | candy notes |
| | Beverage 2 | More rounded profile, much reduced |
| | | aftertaste |
| | Beverage 3 | More mouthfeel, rounded, sugar-like |
| | | taste |
| WITH | Beverage 4 | Sugar-like taste, much cleaner than |
| SACCHARIN | | control |
| | Beverage 5 | More rounded flavor, sugar-like taste, |
| | | equally preferred than blend with |
| | | erythritol |
| | Beverage 6 | More mouthfeel, more rounded, sugar- |
| | | like taste, equally preferred than blend |
| | | with phloretin |
| WITH ACE-K | Beverage 7 | Sugar-like taste, cleaner than control |
| | Beverage 8 | More rounded flavor, less aftertaste, |
| | | sugar-like taste |
| | Beverage 9 | Improved mouthfeel, more rounded, |
| | | sugar-like taste, most preferred in the |
| | | ace-K group |

All panelists agreed that the sweetness intensity of the blends (Beverages 1-9) was very close to the control. Blends showed taste quality improvement compared to the control (sugar-like taste, less sweetness linger, less bitterness aftertaste). Addition of phloretin (Beverage 2, 5 and 8) and erythritol (Beverage 3, 6 and 9) brought more improvement (more roundness, more body) to the beverages and were the most preferred by panelists.

### Example 5: Soymilk Beverage Containing Reb M and Sucralose

The following ingredients (in grams) were used to make 1000 grams of beverage:

Formulation 1: Beverage with Reb M (45 ppm) and
Sucralose (20 ppm) (pH 7.1, Brix 5.0)

| | |
|---|---|
| Soybean milk base | 752.63 |
| Maltodextrin | 2.83 |
| Xanthan Gum | 0.10 |
| Gellan Gum | 0.30 |
| Sodium Chloride | 1.00 |
| Calcium Carbonate | 3.00 |
| Vitamin Premix | 0.20 |
| Sucralose | 0.02 |
| Rebaudioside-M | 0.045 |
| Soy Lecithin | 0.04 |
| Milk Flavors | 3.3 |
| Treated Water | 236.53 |
| TOTAL (grams) | 1000.00 |

Formulation 2: Control-1 Beverage with
Reb M (125 ppm) and Allulose (pH 7.2, Brix 4.83)

| | |
|---|---|
| Soybean Milk base | 752.63 |
| Maltodextrin | 2.83 |
| Allulose Syrup | 3.90 |
| (71% solids) | |
| Xanthan Gum | 0.10 |
| Gellan Gum | 0.30 |
| Sodium Chloride | 1.00 |
| Calcium Carbonate | 3.00 |
| Vitamin Premix | 0.20 |
| Stevia reb-M | 0.1250 |
| Soy Lecithin | 0.0440 |
| Milk Flavors | 3.52 |
| Treated Water | 232.35 |
| TOTAL (grams) | 1000.00 |

Formulation 3: Control-2 Beverage with
Sucrose and Sucralose (pH 7.4, Brix 10.5)

| | |
|---|---|
| Soybean milk base | 752.63 |
| Saccharides Syrup | 18.53 |
| Sucrose | 2.828 |
| Xanthan | 0.100 |
| Gellan Gum | 0.300 |
| Sodium Chloride | 1.000 |
| Calcium Carbonate | 3.000 |
| Tri-sodium Citrate | 1.000 |
| Vitamin Premix | 0.200 |
| Sucralose | 0.0200 |
| Soy Lecithin | 0.044 |
| Milk Flavors | 2.700 |
| Treated Water | 217.648 |
| TOTAL (grams) | 1000.00 |

The ingredients for each formulation (1-3) were mixed in water until complete dissolved. After complete dissolution the beverage was pre-heated (80° C.), de-aerated, then heat-processed (Ultra High Temperature, 137° C. for 17 sec), cooled down to 80° C. and homogenized (154+70 kg/cm2, 2 passes, 70° C.). The beverage was cooled, packaged and stored refrigerated until taste evaluation.

Sensory Results

The three formulations were evaluated blindly by 5-6 experienced panelists. They all agreed that the Formulation 1 (beverage with reb-M and sucralose) tasted very close to Control-2 (beverage with sucrose and sucralose) which carries more calories and is currently commercialized.

Panelists agreed that the Formulation 1 (beverage with reb-M and sucralose) showed an improved taste profile (sugar-like taste, more rounded flavor clean finish) compared with Formulation 2 (Control-1 with reb-M and allulose).

### Example 6: Soymilk Beverage Containing Reb-M, Sucralose and Juice— pH 4

The following ingredients (in grams) were used to make 1000 grams of beverage:

Formulation 4: Beverage with Reb M (50 ppm) and
Sucralose (100) (pH 4, Brix 2.5)

| | |
|---|---|
| Soybean Milk Base | 140.47 |
| Maltodextrin | 18.417 |
| Pectin | 1.768 |
| Citric Acid, anhydrous | 0.4025 |
| Calcium Chloride | 0.27 |
| Vitamin Premix | 0.050 |
| Sucralose | 0.1000 |
| Stevia Reb-M | 0.0500 |
| Apple Flavor | 1.0000 |
| Apple Juice | 20.00 |
| Concentrate, 70 Brix | |
| Ascorbic Acid | 0.20 |
| Citric Acid, anhydrous | 0.70 |
| Treated Water | 816.57 |
| TOTAL (grams) | 1000.00 |

Formulation 5: Control-3 Beverage with Reb-M and
Allulose (pH 4, Brix 1.5)

| | |
|---|---|
| Soybean Milk Base | 140.47 |
| Allulose Syrup | 9.8 |
| (71% solids) | |
| Pectin | 1.768 |
| Citric Acid, anhydrous | 0.402 |
| Calcium Chloride | 0.270 |
| Maltodextrin | 18.417 |
| Vitamin Premix | 0.050 |
| Stevia Reb-M | 0.3250 |
| Apple Flavor | 1.09 |
| Apple Juice | 5.00 |
| Concentrate, 70 Brix | |
| Ascorbic Acid | 0.20 |
| Citric Acid, anhydrous | 0.70 |
| Treated Water | 821.2 |
| TOTAL (grams) | 1000.00 |

Formulation 6: Control-4 Beverage with Sucrose and
Sucralose (pH 4, Brix 6.19)

| | |
|---|---|
| Soybean Milk Base | 140.47 |
| Sucrose | 3.417 |
| Pectin | 1.768 |
| Citric Acid, anhydrous | 0.402 |
| Saccharides Syrup | 40.00 |
| Calcium Chloride | 0.270 |
| Maltodextrin | 5.00 |
| Vitamin Premix | 0.050 |
| Sucralose | 0.1200 |
| Apple Flavor | 0.935 |
| Apple Juice Concentrate, | 5.00 |
| 70 Brix | |
| Ascorbic Acid | 0.200 |
| Citric Acid, anhydrous | 1.300 |
| Treated Water | 801.065 |
| TOTAL (grams) | 1000.00 |

The ingredients for each formulation (4-6) were mixed in water until complete dissolved. After complete dissolution the beverage was pre-heated (80° C.), de-aerated, then heat-processed (Ultra High Temperature, 125° C. for 17 sec), cooled down to 80° C. and homogenized (154+70 kg/cm2, 2 passes, 70° C.). The beverage was cooled, packaged and stored refrigerated until taste evaluation.

Sensory Results

The three formulations were evaluated blindly by 5-6 experienced panelists. They all agreed that the Formulation 4 (beverage with reb-M and sucralose) tasted very close to Control-4 (beverage with sucrose and sucralose) which carries more calories and currently commercialized.

Panelists agreed that the Formulation 4 (beverage with reb-M and sucralose) showed an improved taste profile (sugar-like taste, more rounded, sharp flavor with clean finish) compared with Formulation 5 (Control-3 with reb-M and allulose).

1. A beverage comprising (i) a steviol glycoside mixture comprising rebaudioside M and (ii) at least one synthetic sweetener;
wherein the concentration of rebaudioside M is from about 1 ppm to about 250 ppm,
the weight ratio of the steviol glycoside mixture comprising rebaudioside M to the at least one synthetic sweetener is from about 0.5:1 to about 3:1, and
the beverage is selected from a carbonated beverage and a plant protein-containing beverage.

2. The beverage of claim 1, wherein the steviol glycoside mixture comprising rebaudioside M comprises at least about 80% rebaudioside M by weight.

3. The beverage of claim 1, wherein the steviol glycoside mixture comprising rebaudioside M comprises at least about 95% rebaudioside M by weight.

4. The beverage of claim 1, wherein the synthetic sweetener is selected from the group consisting of sucralose, potassium acesulfame, acesulfame acid and salts thereof, aspartame, alitame, saccharin and salts thereof, neohesperidin dihydrochalcone, cyclamate, cyclamic acid and salts thereof, neotame, advantame, glucosylated steviol glycosides (GSGs) and combinations thereof.

5. The beverage of claim 5, wherein the synthetic sweetener is selected from the group consisting of sucralose, acesulfame K, saccharin and combinations thereof.

6. The beverage of claim 1, wherein the at least one synthetic sweetener is present in a concentration from about 1 ppm to about 250 ppm.

7. The beverage of claim 1, further comprising one or more substances selected from the group consisting of erythritol, allulose, cellobiose, hesperetin dihydrochalcone-4′-O-β-D-glucoside and phloretin.

8. The beverage of claim 7, wherein the concentration of phloretin in the beverage is from about 0.1 ppm to about 15 ppm.

9. The beverage of claim 8, wherein the concentration of phloretin in the beverage is from about 0.1 ppm to about 1 ppm.

10. The beverage of claim 7, wherein the amount of erythritol, allulose and/or cellobiose in the beverage is from about 0.1% to about 2% by weight.

11. The beverage of claim 7, wherein the concentration of hesperetin dihydrochalcone-4′-O-β-D-glucoside is from about 0.1 ppm to about 20 ppm.

12. The beverage of claim 1, wherein the beverage is selected from a mid-calorie, low-calorie or zero-calorie beverage.

13. The beverage of claim 12, wherein the beverage is a zero-calorie beverage.

14. The beverage of claim 1, wherein the carbonated beverage is selected from the group consisting of frozen carbonated beverages, enhanced sparkling beverages, cola, fruit-flavored sparkling beverages, ginger-ale, soft drinks and root beer.

15. The beverage of claim 14, wherein the carbonated beverage is a cola.

16. The beverage of claim 1, wherein the plant protein-containing beverage is selected from the group consisting of coconut milk, oat milk, cashew milk, almond milk and soy milk.

17. The beverage of claim 1, wherein the sucrose equivalence of the beverage is at least about 8%.
